(19) United States
(12) Patent Application Publication
(10) Pub. No.: US 2026/0334357 A1
(43) Pub. Date: Oct. 29, 2026

(54) MOWING APPARATUS AND ROBOTIC LAWN MOWER

(71) Applicant: SHENZHEN HANYANG TECHNOLOGY CO., LTD., Shenzhen (CN)

(72) Inventors: Taotao ZHU, Shenzhen (CN); Yongqi SONG, Shenzhen (CN); Haitao LI, Shenzhen (CN); Weiyue CHEN, Shenzhen (CN)

(21) Appl. No.: 19/702,831

(22) Filed: Jun. 9, 2026

Related U.S. Application Data
(63) Continuation of application No. PCT/CN2024/091683, filed on May 8, 2024.

(30) Foreign Application Priority Data
Apr. 22, 2024 (CN) 202410481058.6

(51) Int. Cl. A01D 34/74; A01D 34/00; A01D 101/00

(52) U.S. Cl. CPC A01D 34/74; A01D 34/008; A01D 2101/00

(57) ABSTRACT

The present disclosure relates to a mowing apparatus and a robotic lawn mower. The mowing apparatus includes a support frame, a lift assembly mounted to the support frame, a cutting assembly mounted to the lift assembly, and a restoring member. The lift assembly is configured to drive the cutting assembly to ascend and descend and includes a first plate movable relative to a support frame, and a second plate overlying the first plate. The cutting assembly is fixedly coupled to the second plate. The second plate is configured to undergo adaptive movement relative to the first plate in a vertical direction or a horizontal direction, in response to an external force applied to the cutting assembly. The restoring member is configured to restore the second plate toward a prior position after the adaptive movement.

### CROSS-REFERENCE TO RELATED APPLICATIONS

The present patent document claims the priority to and benefits of PCT Application No. PCT/CN2024/091683 filed on May 8, 2024, which further claims priority to and the benefits of Chinese Patent Application No. 202410481058.6 filed on Apr. 22, 2024, the contents of each of which are hereby incorporated by reference.

### TECHNICAL FIELD

The present disclosure relates to a mowing apparatus, and in particular, to a mowing apparatus mounted on a self-propelled device.

### BACKGROUND

Mowing apparatuses are widely used in agriculture, gardening, parks, and other fields due to advantages such as efficient mowing, safety and reliability, environmental friendliness, and energy saving. Their precise mowing, versatility, and user-friendly design significantly improve lawn-maintenance efficiency and are favored by users.

In related technologies, a mowing apparatus can block most obstacles on a lawn by means of a blocking structure, but some relatively small obstacles may still remain. These obstacles may collide with a cutting assembly, which may easily damage the cutting assembly and increase maintenance and replacement costs. In addition, when the mowing apparatus passes over a mound, turf at the top of the mound may be cut flat by the cutting assembly, thereby damaging turf quality and affecting the overall mowing effect. In other words, the mowing apparatuses in the related technologies exhibit poor adaptability under the foregoing operating conditions.

### SUMMARY

The present disclosure provides a mowing apparatus and a robotic lawn mower. In some embodiments, when the mowing apparatus contacts an obstacle or a raised mound, a lift assembly is configured to adjust a height of a cutter disk, and may undergo adaptive movement within a range, thereby improving traversability of the mowing apparatus.

The present disclosure may achieve the foregoing objectives through the following technical solutions.

The present disclosure provides a mowing apparatus. In some embodiments, the mowing apparatus comprises a support frame; a lift assembly mounted to the support frame; a cutting assembly mounted to the lift assembly, and a restoring member, wherein the lift assembly is configured to drive the cutting assembly to ascend and descend; the lift assembly comprises a first plate configured to ascend or descend relative to the support frame, and a second plate overlying the first plate; the cutting assembly is fixedly coupled to the second plate; the second plate is configured to undergo adaptive movement relative to the first plate in a vertical direction or a horizontal direction, in response to an external force applied to the cutting assembly; and the restoring member is configured to restore the second plate toward a prior position after the adaptive movement.

In some embodiments, the lift assembly may include a guide post mounted to the support frame, the guide post extending through the first plate and the second plate, and the first plate and the second plate being configured to ascend or descend along a longitudinal direction of the guide post.

In some embodiments, the lift assembly may include at least one sensing assembly, the sensing assembly comprising a magnet and a magnetic sensor configured to sense the magnet, the magnet being configured to ascend and descend with the first plate, the magnetic sensor being stationary relative to the support frame, and the magnetic sensor cooperating with the magnet to limit a range of ascent and descent of the cutting assembly together with the first plate.

In some embodiments, the lift assembly may include a mounting plate mounted to a top portion of the guide post and disposed above the second plate; a lift motor mounted to the mounting plate; and a lead-screw drive assembly coupled to an output end of the lift motor and drivingly coupled to the first plate, the lead-screw drive assembly being configured to drive the first plate to ascend and descend.

In some embodiments, the magnetic sensor is disposed below the mounting plate at a position corresponding to a maximum ground clearance of the cutting assembly, and the magnetic sensor cooperates with the magnet to prevent the cutting assembly from ascending beyond the maximum ground clearance.

In some embodiments, a limiting member is fixedly mounted below the mounting plate, the limiting member extending from a bottom of the mounting plate toward the second plate, the second plate being configured to ascend into abutment with the limiting member, and the limiting member being configured to at least one of: (i) limit the second plate from rising higher than a bottom of the limiting member, or (ii) limit adaptive movement of the second plate when the second plate is at a raised position.

In some embodiments, the second plate defines a through hole, the guide post extends through the through hole, and a clearance is provided between an inner wall of the through hole and an outer wall of the guide post.

In some embodiments, a ratio of a diameter of the through hole to a diameter of the guide post is in a range of 1.2 to 2.5.

In some embodiments, the first plate is provided with a guide sleeve disposed around an outer side of the guide post, and a carrier member is provided above the guide sleeve, a cross-section of the carrier member gradually decreasing from a bottom of the carrier member toward a top of the carrier member; the second plate is provided with a socket member disposed around an outer side of the carrier member, an inner-surface contour of the socket member being shaped to match an outer contour of the carrier member.

In some embodiments, the carrier member and the guide sleeve are integrally formed.

In some embodiments, an outer surface of the carrier member has a shape selected from the group consisting of a cone, a truncated cone, a pyramid, and a truncated pyramid.

In some embodiments, an angle between an outer surface of the carrier member and a bottom plane of the carrier member is in a range of 30 degrees to 70 degrees.

In some embodiments, the carrier member includes, at a top portion thereof, a step portion extending upwardly, and the socket member includes, on an inner surface thereof, an extension structure shaped to match the step portion.

In some embodiments, the restoring member comprises an elastic member having a first end coupled to the first plate and a second end coupled to the second plate, the elastic member being configured to restore the second plate toward a prior position after the adaptive movement.

The present disclosure further provides a robotic lawn mower. In some embodiments, the robotic lawn mower comprises a self-propelled device and the mowing apparatus described above, where the mowing apparatus is disposed on the self-propelled device and is configured to perform a mowing operation in a preset area when driven by the self-propelled device.

The present technology may include the following beneficial effects: the mowing apparatus of the present disclosure may address an issue in which a cutting assembly of certain existing mowing apparatuses may lack adaptive regulation when contacting an obstacle or a mound. In some embodiments, in addition to its function of adjusting a cutter disk height, the lift assembly may accommodate adaptive movement within a range. As a result, traversability of the mowing apparatus may be improved, flattening of the mound may be avoided, and overall aesthetic quality of a lawn may be improved. In addition, the adaptive movement may reduce machine wear caused by collision of the cutting assembly with an obstacle, and may reduce maintenance cost associated with such wear.

### BRIEF DESCRIPTION OF THE DRAWINGS

To describe technical solutions in implementations of the present disclosure more clearly, accompanying drawings required by description of the implementations will be briefly described below. The accompanying drawings in the following description merely show some implementations of the present disclosure, and those of ordinary skill in the art may still derive other accompanying drawings from these accompanying drawings without creative efforts.

FIG. 1 shows a schematic diagram of a mowing apparatus according to some embodiments of the present disclosure;

FIG. 2 shows a schematic diagram of an internal structure of a mowing apparatus according to some embodiments of the present disclosure;

FIG. 3 shows a schematic diagram of an enlarged view of a part A from a perspective of FIG. 2;

FIG. 4 shows a schematic diagram of an internal structure of a mowing apparatus undergoing an adaptive movement according to some embodiments of the present disclosure;

FIG. 5 shows a schematic diagram of an enlarged view of a part B from a perspective of FIG. 4;

FIG. 6 shows a schematic diagram of an exploded view of a lift assembly according to some embodiments of the present disclosure;

FIG. 7 shows a schematic structural diagram of a carrier member according to some embodiments of the present disclosure; and

FIG. 8 shows a schematic diagram of a robotic lawn mower according to some embodiments of the present disclosure.

### DESCRIPTION OF REFERENCE NUMERALS

100. mowing apparatus;
10. support frame;
20. lift assembly; 21. first plate; 22. second plate; 221. through hole; 23. guide post; 24. mounting plate; 25. lift motor; 26. lead-screw drive assembly; 261. lead-screw body; 262. lead-screw nut; 27. guide sleeve; 28. carrier member; 281. step portion; 29. socket member; 50. sensing assembly; 51. magnet; 52. magnetic sensor; 53. limiting member;
30. cutting assembly;
40. restoring member;
200. self-propelled device; and
1000. robotic lawn mower.

### DETAILED DESCRIPTION

In order to make the technical solutions and features of the present disclosure clearer, the present disclosure will be further described below in detail with reference to the accompanying drawings and the embodiments. It should be understood that the specific embodiments described herein are merely used to illustrate the present disclosure rather than limit the present disclosure.

Technical solutions in the implementations of the present disclosure will be described below clearly and comprehensively in conjunction with the accompanying drawings in the implementations of the present disclosure.

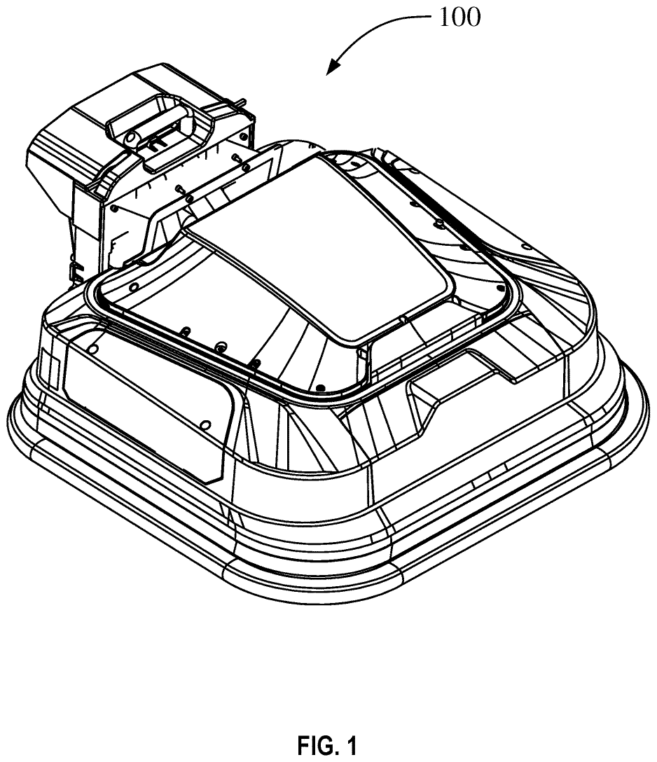

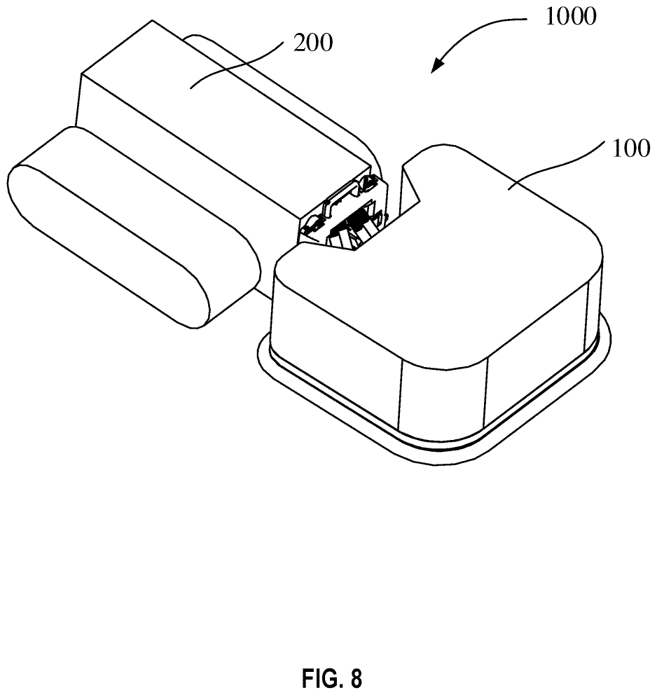

With reference to FIG. 1 and FIG. 8, the present disclosure provides a mowing apparatus 100 and a robotic lawn mower 1000. The mowing apparatus 100 may be mounted to a self-propelled device 200. The self-propelled device 200 may generate a predetermined mowing path based on a mowing area set by a user. The self-propelled device 200 may be a tracked vehicle, a wheeled vehicle, or any other mobile carrier having a mounting position for the mowing apparatus 100. The self-propelled device 200 and the mowing apparatus 100 may be combined to form the robotic lawn mower 1000 to perform mowing operations. The mowing apparatus 100 is configured to perform mowing in a predetermined area along a predetermined path generated by the self-propelled device 200 when driven by the self-propelled device 200.

In certain related mowing apparatus designs, the mowing apparatus 100 may be provided with a lift assembly 20, and a cutting assembly 30 may be fixedly mounted to the lift assembly 20, such that an operator may adjust a height of the cutting assembly 30 relative to ground according to a height of grass before cutting and an intended mowing outcome. When obstacles or mounds are present on a lawn, and heights of such obstacles or mounds exceed a preset cutting height, the cutting assembly 30 of the mowing apparatus 100 may collide with such obstacles or mounds. Such collisions may result in damage to the machine itself, and may also cause flattening of the turf at the top of a mound, which may degrade the quality of the lawn and affect overall aesthetic quality. In view of the foregoing, the applicant has investigated the issue of limited adaptability of the cutting assembly 30 when the mowing apparatus 100 passes over obstacles or mounds.

A structure of the mowing apparatus 100 in the present disclosure will be described in detail below.

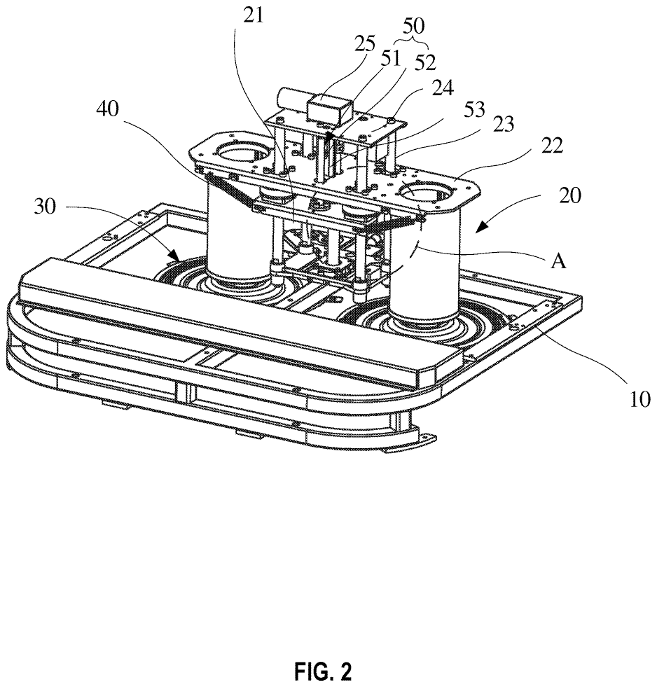

With reference to FIG. 2 to FIG. 5, the present disclosure provides a mowing apparatus 100. In some embodiments, the mowing apparatus 100 comprises a support frame 10, a lift assembly 20 mounted to the support frame 10, and a cutting assembly 30 mounted to the lift assembly 20. The lift assembly 20 is configured to drive the cutting assembly 30 to ascend and descend. The lift assembly 20 comprises a first plate 21 configured to ascend or descend relative to the support frame 10, and a second plate 22 overlying the first plate 21. The cutting assembly 30 is fixedly coupled to the second plate 22, and the second plate 22 is configured to undergo adaptive movement relative to the first plate 21 in a vertical direction or a horizontal direction in response to an external force applied to the cutting assembly 30. The mowing apparatus 100 further comprises a restoring member 40 configured to restore the second plate 22 toward a prior position after the adaptive movement.

In some embodiments, the lift assembly 20 may employ a two-plate design. When the lift assembly 20 adjusts a height, the first plate 21 and the second plate 22 overlying the first plate 21 may both change in height relative to the ground. The cutting assembly 30 may be fixedly coupled to the second plate 22, and the cutting assembly and the second plate may be regarded as a single unit. The first plate 21 and the second plate 22 may be in an overlying relationship—that is, the first plate and the second plate need not have a fixed connection therebetween. When the cutting assembly 30 contacts a mound or an obstacle, a force generated by the contact may displace the second plate 22 and the cutting assembly 30 upward as a unit, temporarily releasing the overlying relationship between the first plate 21 and the second plate 22. In this way, the second plate 22 may disengage from the first plate 21, and may undergo adaptive movement relative to the first plate 21 in a vertical direction or a horizontal direction. A path of the adaptive movement may depend on a direction of the force generated by the contact.

In some embodiments, the mowing apparatus 100 further comprises the restoring member 40. The restoring member 40 may be coupled between the first plate 21 and the second plate 22, and the restoring member 40 may have a constraining function. When the first plate 21 and the second plate 22 disengage from each other, the restoring member 40 may permit the second plate 22 to undergo adaptive movement within an acceptable range. After the mowing apparatus 100 passes over an obstacle or a mound, the restoring member 40 may restore the prior overlying relationship between the first plate 21 and the second plate 22, which may restore a preset mowing height and may promote consistency in the cutting height of a target lawn.

In this way, in some embodiments, the adaptive movement of the second plate 22 relative to the first plate 21, together with the limiting and restoring functions of the restoring member 40, may address the issue of limited adaptability of the cutting assembly 30 when the mowing apparatus 100 passes over obstacles or mounds. In some embodiments, the mowing apparatus 100 may exhibit improved durability, may facilitate a reduction in maintenance cost, may help preserve lawn quality, and may provide an enhanced user experience.

With reference to FIG. 2, in some embodiments, the lift assembly 20 further comprises a guide post 23 mounted to the support frame 10, the guide post 23 extending through the first plate 21 and the second plate 22, and the first plate 21 and the second plate 22 being configured to ascend or descend along a longitudinal direction of the guide post 23. The guide post 23 may extend through the first plate 21 and the second plate 22 and may be mounted to the support frame 10 of the mowing apparatus 100. The guide post 23 may guide the ascending or descending of the first plate 21 and the second plate 22 and the adaptive movement of the second plate 22, such that the first plate 21 and the second plate 22 may move along the guide post 23, and misalignment during the movement may be reduced. In some embodiments, a plurality of guide posts 23 may be arranged according to a space configuration of the mowing apparatus 100, and the plurality of guide posts 23 may be symmetrically distributed. Such an arrangement may reduce shaking and swaying during the ascending or descending of the first plate 21 and the second plate 22 or during the adaptive movement of the second plate 22, may help maintain balance, and may support long-term stable operation of the mowing apparatus 100.

With reference to FIG. 2, in some embodiments, the lift assembly 20 further comprises: a mounting plate 24 mounted to a top of the guide post 23, wherein the mounting plate 24 is disposed above the second plate 22; a lift motor 25 mounted to the mounting plate 24; and a lead-screw drive assembly 26 coupled to an output end of the lift motor 25, wherein the lead-screw drive assembly 26 is drivingly coupled to the first plate 21, and the lead-screw drive assembly 26 is configured to drive the first plate 21 to ascend and descend.

In some embodiments, in the lift assembly 20, the mounting plate 24 may be mounted at the top of the guide post 23, and the mounting plate 24 and the lift motor 25 at the mounting plate 24 may be located above the second plate 22. The lead-screw drive assembly 26 may comprise a lead-screw body 261 and a lead-screw nut 262, and the lead-screw nut 262 may be fixedly coupled to the first plate 21. In some embodiments, a bottom of the lead-screw body 261 may be fixed to the support frame 10, and a top of the lead-screw body may be coupled to the mounting plate 24, with the lead-screw body extending through the lead-screw nut 262. The lead-screw nut 262 may have an internal thread, and the lead-screw body 261 may have an external thread adapted to the lead-screw nut 262, and the lift motor 25 may be drivingly coupled to the lead-screw body 261. When the lift motor 25 operates, the lead-screw drive assembly 26 may convert rotary motion into linear motion, to drive the first plate 21 to ascend or descend along the lead-screw body 261. That is, the lift motor 25 may adjust the height of the first plate 21 relative to the ground, and may adjust the height of the cutting assembly 30, so as to accommodate lawns of different heights or to address obstacles of different heights.

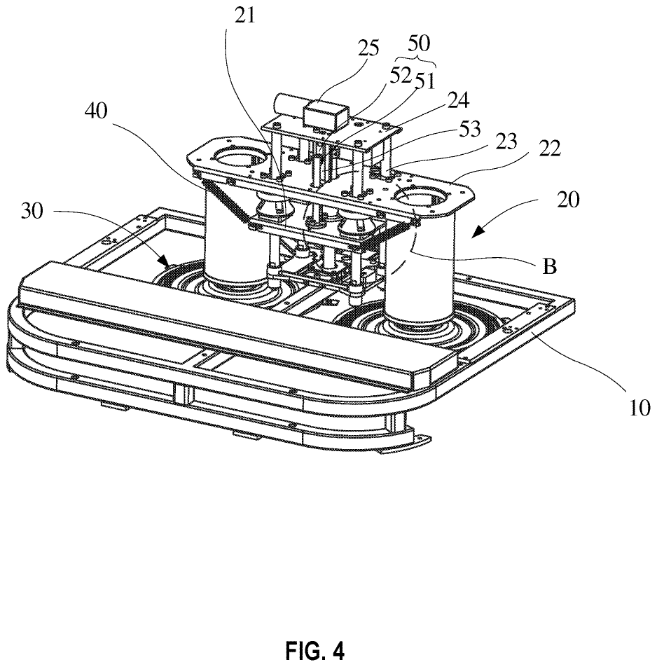

With reference to FIG. 4, in some embodiments, the lift assembly 20 further comprises at least one sensing assembly 50. The sensing assembly 50 comprises a magnet 51 and a magnetic sensor 52 configured to sense the magnet 51, the magnet 51 being configured to ascend and descend with the first plate 21, and the magnetic sensor 52 being stationary relative to the support frame 10. The magnetic sensor 52 cooperates with the magnet 51, to limit a range of ascent and descent of the cutting assembly 30 with the first plate 21.

In some embodiments, the cutting assembly 30 may be mounted under a bottom shell of the mowing apparatus 100. If the cutting assembly 30 ascends too high with the first plate 21, the bottom shell may be damaged by the cutting assembly 30. If the cutting assembly 30 descends too low with the first plate 21, the cutting assembly 30 may come into direct contact with the lawn and rub against the ground for a prolonged period, which may damage the lawn and may affect a service life of the cutting assembly 30. In some embodiments, the magnetic sensor 52 may be fixedly arranged at a high position or a low position of the lift assembly 20, and the magnet 51 may be arranged opposite the magnetic sensor 52 and may be configured to ascend and descend with the first plate 21. When the magnet 51 moves to a same height as the magnetic sensor 52, the magnetic sensor 52 may transmit a stop signal to the lift motor 25, which may inhibit damage to the mowing apparatus 100 otherwise caused by ascent or descent of the first plate 21 beyond an allowable range.

In some embodiments, the magnetic sensor 52 is arranged below the mounting plate 24 at a position corresponding to a maximum ground clearance of the cutting assembly 30, and the magnetic sensor 52 cooperates with the magnet 51, to prevent the cutting assembly 30 from ascending with the first plate 21 beyond the maximum ground clearance.

In some embodiments, the mounting plate 24 may be located at a high position of the lift assembly 20 and may be stationary relative to the support frame 10. The magnetic sensor 52 may be fixedly coupled to the bottom of the mounting plate 24 such that the magnetic sensor 52 remains stationary relative to the support frame 10. The magnet 51 may be arranged at a position adapted to the magnetic sensor 52, and may be configured to ascend and descend with the first plate 21. When the magnet 51 ascends to the height of the magnetic sensor 52, the magnetic sensor 52 may transmit the stop signal to the lift motor 25, which may inhibit the first plate 21 from ascending continuously. In this way, the mowing apparatus 100 may be protected from damage caused by the cutting assembly 30.

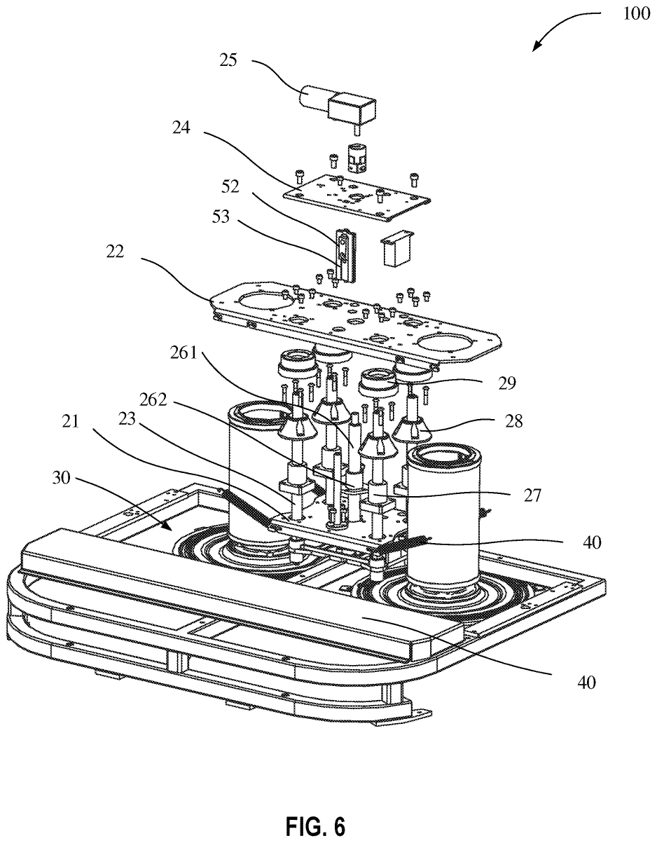

With reference to FIG. 4 to FIG. 6, in some embodiments, a limiting member 53 is fixedly mounted below the mounting plate 24, the limiting member 53 extending from a bottom of the mounting plate 24 toward the second plate 22, the second plate 22 being configured to ascend into abutment with the limiting member 53, and the limiting member 53 being configured to at least one of: (i) limit the second plate 22 from rising higher than a bottom of the limiting member 53, or (ii) limit adaptive movement of the second plate 22 when the second plate 22 is at a raised position.

In some embodiments, the limiting member 53 arranged at the bottom of the mounting plate 24 of the lift assembly 20 may serve one or more functions described below. As a structural limit, the limiting member 53 may prevent the second plate 22 from further ascent when the second plate 22 abuts against the bottom of the limiting member. In this way, additional protection may be provided for the bottom shell of the mowing apparatus 100, and the bottom shell may be protected from damage by the cutting assembly 30 even if the sensing assembly 50, which controls stopping of the lift motor 25, fails. In addition, when the second plate 22 abuts against the limiting member 53 at the raised position, the limiting member 53 may limit a range of shaking during the adaptive movement of the second plate 22 at the raised position, which may avoid damage to the bottom shell by the cutting assembly 30 due to the adaptive movement.

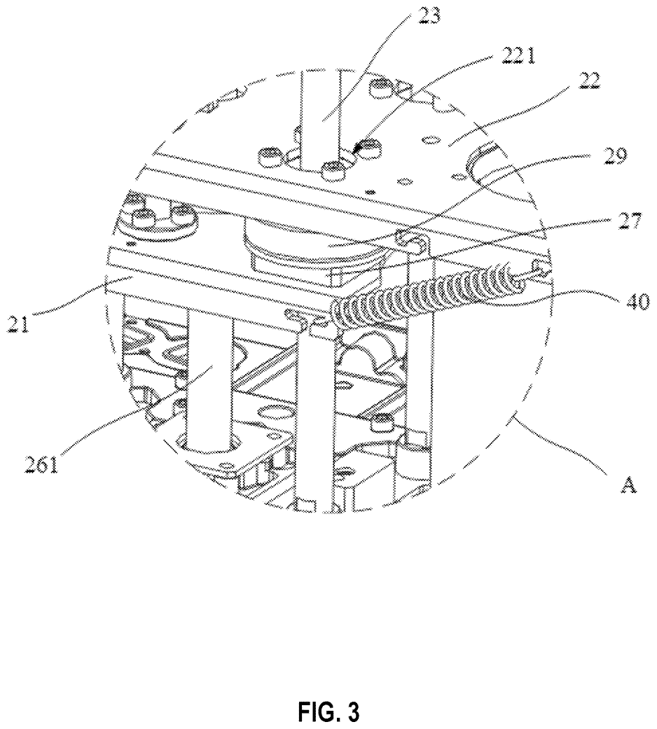

With reference to FIG. 3, in some embodiments, the second plate 22 defines a through hole 221, the guide post 23 extending through the through hole 221, and a clearance is provided between an inner wall of the through hole 221 and an outer wall of the guide post 23.

When the cutting assembly 30 of the mowing apparatus 100 contacts an obstacle or a mound on the lawn, a force of the contact may act on the cutting assembly 30 and the second plate 22, and the cutting assembly 30 and the second plate 22 may move vertically upward along the guide post 23. When the second plate 22 disengages from the first plate 21, the second plate 22 may have a range of movement in the horizontal direction in addition to the vertical upward movement. The radial clearance between the inner wall of the through hole 221 in the second plate 22 and the outer wall of the guide post 23 may determine the range of movement in the horizontal direction. With such a design, the mowing apparatus 100 may be provided with adaptive movement in the horizontal direction, and traversability of the mowing apparatus 100 when the cutting assembly 30 contacts an obstacle or a mound may be improved.

With reference to FIG. 3, in some embodiments, the range of a ratio of a diameter of the through hole 221 to a diameter of the guide post 23 may be in a range of 1.2 to 2.5.

To accommodate adaptive movement of the mowing apparatus 100, the radial clearance between the inner wall of the through hole 221 in the second plate 22 and the outer wall of the guide post 23 may be selected to avoid being too small. When the ratio of the diameter of the through hole 221 to the diameter of the guide post 23 is less than 1.2, the range of movement in the horizontal direction of the second plate 22 may be relatively small, which may limit the adaptive movement flexibility of the mowing apparatus 100. When the ratio of the diameter of the through hole 221 to the diameter of the guide post 23 is greater than 2.5, the range of movement in the horizontal direction of the second plate 22 may be relatively large. As a result, the cutting assembly 30 may exhibit an excessive swing amplitude, the stability of the mowing apparatus 100 may be reduced, a cutting range of the cutting assembly 30 may be exceeded, and a shell of the mowing apparatus 100 may be subject to damage. In some embodiments, the ratio of the diameter of the through hole 221 of the second plate 22 to the diameter of the guide post 23 may be in a range of 1.2 to 2.5, and a specific ratio may be, for example, 1.4, 1.6, 2.0, or any value within the range.

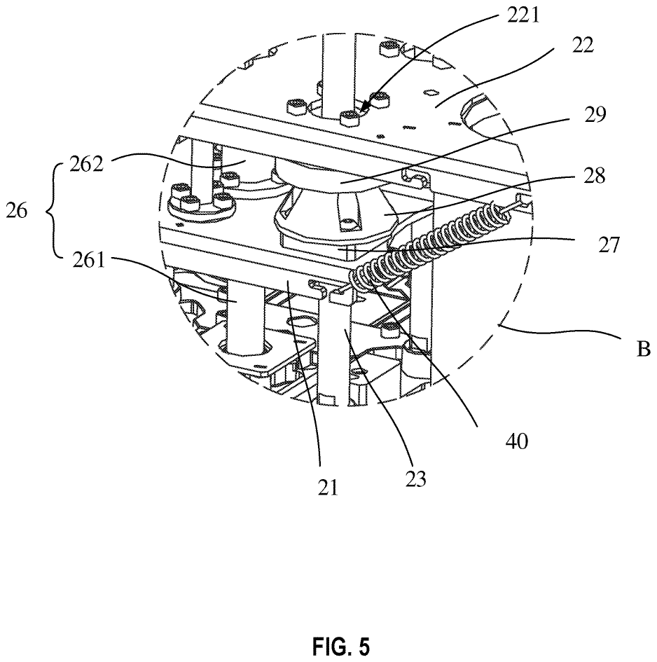

With reference to FIG. 3 and FIG. 5, in some embodiments, the first plate 21 is provided with a guide sleeve 27, the guide sleeve 27 being disposed around an outer side of the guide post 23, a carrier member 28 being arranged above the guide sleeve 27, and a cross section of the carrier member 28 gradually decreasing from a bottom of the carrier member toward a top of the carrier member.

In some embodiments, the second plate 22 is provided with a socket member 29, the socket member 29 being disposed around an outer side of the carrier member 28, and a contour of an inner surface of the socket member 29 being shaped to match an outer contour of the carrier member 28.

In some embodiments, the guide sleeve 27 cooperates with the guide post 23. The arrangement of the guide sleeve 27 may promote movement of the first plate 21 along the guide post 23 during an ascending or descending process, which may reduce friction between the first plate 21 and the guide post 23 during the ascending or descending process. An outer side of the carrier member 28 above the guide sleeve 27 may be shaped to match the contour of the inner surface of the socket member 29 of the second plate 22. In this way, the overlying relationship between the second plate 22 and the first plate 21 may be implemented, and the second plate 22 may be supported by the first plate 21 and may move upward until the cutting assembly 30 contacts an obstacle or a mound on the lawn, at which point the second plate 22 may disengage from the first plate 21. After traversal of the obstacle or mound is completed, the second plate 22 and the cutting assembly 30 mounted to the second plate 22 may move downward along the guide post 23 under the influence of gravity and the restoring member 40 until the overlying relationship between the second plate 22 and the first plate 21 is restored.

In some embodiments, the carrier member 28 may have a cross-sectional area that gradually decreases from bottom to top, which may provide a guiding function. In this way, during the descent of the second plate 22, the socket member 29 may more readily engage with the carrier member 28 under guidance of the carrier member 28. Failure to restore the second plate 22 due to misalignment between the second plate 22 and the first plate 21 may thereby be reduced.

In some embodiments, the carrier member 28 and the guide sleeve 27 are integrally formed as a unitary structure. The carrier member 28 and the guide sleeve 27 may be integrally molded or cast, or may form the unitary structure through welding or other processes.

With reference to FIG. 5, in some embodiments, an outer surface of the carrier member 28 has a shape selected from the group consisting of a cone, a truncated cone, a pyramid, and a truncated pyramid.

In some embodiments, a shape of the outer surface of the carrier member 28 may affect the engagement and disengagement of the first plate 21 and the second plate 22. The carrier member 28 having the outer surface in a shape of the cone or the truncated cone may reduce friction during a nesting process of the carrier member 28 and the socket member 29, such that the second plate 22 may ascend or descend more smoothly, which may improve the flexibility of the apparatus. The carrier member 28 having the outer surface in a shape of the pyramid or the truncated pyramid may have improved anti-deviation performance. In some embodiments, the carrier member may be less susceptible to slight vibration when the first plate 21 and the second plate 22 are in the overlying relationship, which may improve the stability of the apparatus. A designer may select the carrier member 28 having the outer surface in any shape of the cone, the truncated cone, the pyramid, or the truncated pyramid according to design considerations, to achieve a desired mechanical performance, and the foregoing shapes are not limiting.

In some embodiments, an angle between an outer surface of the carrier member 28 and a bottom plane of the carrier member may be in a range of 30 degrees to 70 degrees.

In some embodiments, the angle between the outer surface of the carrier member 28 and the bottom plane of the carrier member may affect a degree of the engagement or disengagement of the carrier member 28 and the socket member 29. In some embodiments, when the angle is larger, for example, 60 degrees, the overlying relationship of the second plate 22 and the first plate 21 may be more stable. That is, the cutting assembly 30 may be subjected to a larger force to cause the socket member 29 to disengage from or engage with the carrier member 28.

Conversely, in some embodiments, when the angle is smaller, for example, 45 degrees, the engagement of the second plate 22 and the first plate 21 may be more flexible. That is, the cutting assembly 30 may be subjected to a smaller force to cause the socket member 29 to disengage from or engage with the carrier member 28. A design with a smaller angle may be applicable to working environments that involve flexibility and rapid adjustment, such as scenarios that involve frequent traversal of obstacles or adaptation to varying lawn conditions.

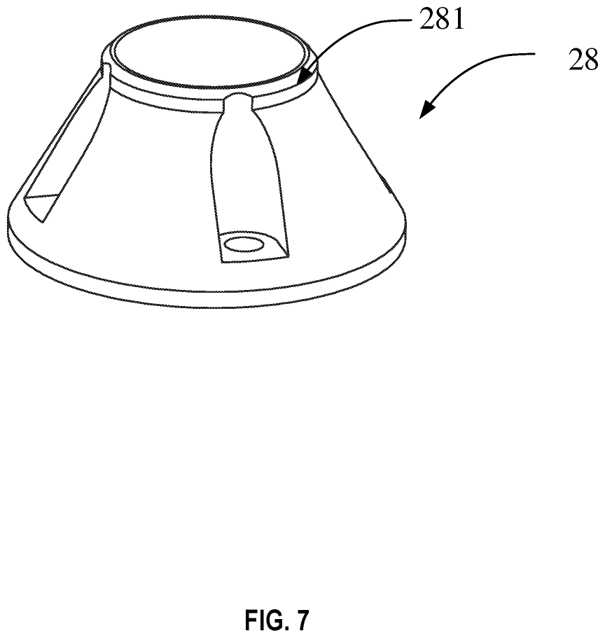

With reference to FIG. 5 and FIG. 7, in some embodiments, a top of the carrier member 28 comprises a step portion 281 extending upwardly, and the inner surface of the socket member 29 comprises an extension structure shaped to match the step portion 281.

In some embodiments, the step portion 281 extending upwardly may limit a movement of the socket member 29 in the horizontal direction to a degree. In this way, the socket member 29 may be inhibited from disengaging from the carrier member 28 due to slight shaking generated by the mowing apparatus 100 during operation when the cutting assembly 30 is not in contact with an obstacle, which may improve the structural stability of the apparatus.

With reference to FIG. 2, in some embodiments, the restoring member 40 comprises an elastic member, a first end of the elastic member being coupled to the first plate 21, a second end of the elastic member being coupled to the second plate 22, and the elastic member being configured to restore the second plate 22 toward a prior position after the adaptive movement.

In some embodiments, the first plate 21 and the second plate 22 may be provided with mounting positions for the elastic member, and an elastic force of the elastic member may affect a return speed of the second plate 22 after disengagement from the first plate 21. The designer may select an elastic force of the elastic member, in conjunction with the structure of the apparatus, such that the return speed of the second plate 22 may be moderate, the second plate 22 may return relatively quickly, and stability may be maintained.

The present disclosure further provides a robotic lawn mower 1000. In some embodiments, the robotic lawn mower comprises a self-propelled device 200 and the mowing apparatus 100 described above. The mowing apparatus 100 is mounted on the self-propelled device 200, and is configured to perform a mowing operation in a preset area when driven by the self-propelled device 200.

In some embodiments, the self-propelled device 200 may be a mobile vehicle body. The mobile vehicle body may employ various designs, such as a tracked vehicle or a wheeled vehicle, and may move across different terrain and environmental conditions. In some embodiments, the self-propelled device 200 may include a positioning technology, such as a Global Positioning System (GPS) or an inertial navigation system, and the self-propelled device 200 may be positioned accordingly. The self-propelled device 200 may also be equipped with an obstacle avoidance system, such as an ultrasonic obstacle avoidance system, a visual obstacle avoidance system, or an infrared obstacle avoidance system. In this way, the self-propelled device may avoid obstacles and may move according to a preset path during operation. In some embodiments, the self-propelled device 200 may be equipped with the mowing apparatus 100 described above, and the robotic lawn mower 1000 may mow a lawn in a designated area when driven by the self-propelled device 200. In some embodiments, an entire mowing process may not need manual operation, a capability to independently complete a mowing task may be achieved, labor inputs may be reduced, and the mowing task may be completed in different scenarios.

In the description of the present disclosure, it should be understood that the orientation or positional relationships indicated by the terms “length,” “width,” “depth,” “up,” “down,” and the like are based on the orientation or positional relationship shown in the accompanying drawings, are merely provided to facilitate the description of the present disclosure and to simplify the description, and are not intended to indicate or imply that a device or element referred to has a particular orientation or is constructed and operated in a particular orientation, and thus should not be interpreted as a limitation on the present disclosure. The terms such as “mount” and “couple” should be understood in a broad sense. For example, they may denote fixed coupling, detachable coupling, integral coupling, driving coupling, direct coupling, or indirect coupling through an intermediate medium. For those of ordinary skill in the art, specific meanings of the above terms in the present disclosure may be understood according to specific circumstances.

In addition, the terms “first,” “second,” and the like are merely used for distinguishing description and should not be construed as indicating any specific structure. The phrase “in some embodiments” indicates that specific features, structures, materials, or characteristics described in conjunction with the embodiment or example are included in at least one embodiment or example of the present disclosure. In the present disclosure, illustrative expressions of the terms do not necessarily refer to the same embodiment or example. Furthermore, the specific features, structures, materials or characteristics described may be combined in any one or more embodiments or examples in a suitable manner. In addition, those of ordinary skill in the art may combine and group different embodiments or examples and features in different embodiments or examples described in the present disclosure where there is no conflict.

The embodiments described above are merely used to describe the technical solution of the present disclosure rather than to limit the same. Although the present disclosure has been described in detail with reference to the foregoing embodiments, those of ordinary skill in the art should understand that the technical solution described in the foregoing embodiments may still be modified, or some technical features therein may be equivalently substituted. Such modifications or substitutions do not cause the essence of the corresponding technical solution to depart from the spirit and scope of the technical solutions of the embodiments of the present disclosure, and shall fall within the protection scope of the present disclosure.

1. A mowing apparatus, comprising:
a support frame;
a lift assembly mounted to the support frame;
a cutting assembly mounted to the lift assembly; and
a restoring member, wherein:
the lift assembly is configured to drive the cutting assembly to ascend and descend;
the lift assembly comprises a first plate configured to ascend or descend relative to the support frame, and a second plate overlying the first plate;
the cutting assembly is fixedly coupled to the second plate;
the second plate is configured to undergo adaptive movement relative to the first plate in a vertical direction or a horizontal direction, in response to an external force applied to the cutting assembly; and
the restoring member is configured to restore the second plate toward a prior position after the adaptive movement.

2. The mowing apparatus according to claim 1, wherein the lift assembly comprises a guide post mounted to the support frame, the guide post extending through the first plate and the second plate, and the first plate and the second plate being configured to ascend or descend along a longitudinal direction of the guide post.

3. The mowing apparatus according to claim 2, wherein the lift assembly comprises:
a mounting plate mounted to a top portion of the guide post and disposed above the second plate;
a lift motor mounted to the mounting plate; and
a lead-screw drive assembly coupled to an output end of the lift motor and drivingly coupled to the first plate, the lead-screw drive assembly being configured to drive the first plate to ascend and descend.

4. The mowing apparatus according to claim 3, wherein the lift assembly comprises at least one sensing assembly, the sensing assembly comprising a magnet and a magnetic sensor configured to sense the magnet, the magnet being configured to ascend and descend with the first plate, the magnetic sensor being stationary relative to the support frame, and the magnetic sensor cooperating with the magnet to limit a range of ascent and descent of the cutting assembly together with the first plate.

5. The mowing apparatus according to claim 4, wherein:
the magnetic sensor is disposed below the mounting plate at a position corresponding to a maximum ground clearance of the cutting assembly, and
the magnetic sensor cooperates with the magnet to prevent the cutting assembly from ascending beyond the maximum ground clearance.

6. The mowing apparatus according to claim 3, wherein a limiting member is fixedly mounted below the mounting plate, the limiting member extending from a bottom of the mounting plate toward the second plate, the second plate being configured to ascend into abutment with the limiting member, and the limiting member being configured to at least one of: (i) limit the second plate from rising higher than a bottom of the limiting member, or (ii) limit adaptive movement of the second plate when the second plate is at a raised position.

7. The mowing apparatus according to claim 2, wherein the second plate defines a through hole, the guide post extends through the through hole, and a clearance is provided between an inner wall of the through hole and an outer wall of the guide post.

8. The mowing apparatus according to claim 7, wherein a ratio of a diameter of the through hole to a diameter of the guide post is in a range of 1.2 to 2.5.

9. The mowing apparatus according to claim 2, wherein:
the first plate is provided with a guide sleeve disposed around an outer side of the guide post, a carrier member being provided above the guide sleeve, a cross-section of the carrier member gradually decreasing from a bottom of the carrier member toward a top of the carrier member; and
the second plate is provided with a socket member disposed around an outer side of the carrier member, an inner-surface contour of the socket member being shaped to match an outer contour of the carrier member.

10. The mowing apparatus according to claim 9, wherein the carrier member and the guide sleeve are integrally formed.

11. The mowing apparatus according to claim 9, wherein an outer surface of the carrier member has a shape of a cone, a truncated cone, a pyramid, or a truncated pyramid.

12. The mowing apparatus according to claim 9, wherein an angle between an outer surface of the carrier member and a bottom plane of the carrier member is in a range of 30 degrees to 70 degrees.

13. The mowing apparatus according to claim 9, wherein:
the carrier member comprises, at a top portion thereof, a step portion extending upwardly, and
the socket member comprises, on an inner surface thereof, an extension structure shaped to match the step portion.

14. The mowing apparatus according to claim 1, wherein the restoring member comprises an elastic member having a first end coupled to the first plate and a second end coupled to the second plate, the elastic member being configured to restore the second plate toward the prior position after the adaptive movement.

15. A robotic lawn mower, comprising a self-propelled device and a mowing apparatus, wherein:
the mowing apparatus comprises:
a support frame;
a lift assembly mounted to the support frame;
a cutting assembly mounted to the lift assembly; and
a restoring member, wherein:
the lift assembly is configured to drive the cutting assembly to ascend and descend;
the lift assembly comprises a first plate configured to ascend or descend relative to the support frame, and a second plate overlying the first plate;
the cutting assembly is fixedly coupled to the second plate;
the second plate is configured to undergo adaptive movement relative to the first plate in a vertical direction or a horizontal direction, in response to an external force applied to the cutting assembly; and
the restoring member is configured to restore the second plate toward a prior position after the adaptive movement; and
the mowing apparatus is mounted on the self-propelled device and is configured to perform a mowing operation in a preset area when driven by the self-propelled device.

16. The robotic lawn mower according to claim 15, wherein the lift assembly comprises a guide post mounted to the support frame, the guide post extending through the first plate and the second plate, and the first plate and the second plate being configured to ascend or descend along a longitudinal direction of the guide post.

17. The robotic lawn mower according to claim 16, wherein the lift assembly comprises:
a mounting plate mounted to a top portion of the guide post and disposed above the second plate;
a lift motor mounted to the mounting plate; and
a lead-screw drive assembly coupled to an output end of the lift motor and drivingly coupled to the first plate, the lead-screw drive assembly being configured to drive the first plate to ascend and descend.

18. The robotic lawn mower according to claim 16, wherein:
the first plate is provided with a guide sleeve disposed around an outer side of the guide post, a carrier member being provided above the guide sleeve, a cross-section of the carrier member gradually decreasing from a bottom of the carrier member toward a top of the carrier member; and
the second plate is provided with a socket member disposed around an outer side of the carrier member, an inner-surface contour of the socket member being shaped to match an outer contour of the carrier member.

19. The robotic lawn mower according to claim 15, wherein the restoring member comprises an elastic member having a first end coupled to the first plate and a second end coupled to the second plate, the elastic member being configured to restore the second plate toward the prior position after the adaptive movement.

20. The robotic lawn mower according to claim 18, wherein an outer surface of the carrier member has a shape of a cone, a truncated cone, a pyramid, or a truncated pyramid.
